(19) United States
(12) Patent Application Publication
(10) Pub. No.: US 2026/0340501 A1
(43) Pub. Date: Oct. 29, 2026

(54) MACHINE LEARNING SYSTEM, MACHINE LEARNING METHOD, AND RECORDING MEDIUM

(71) Applicant: Hitachi, Ltd., Tokyo (JP)

(72) Inventors: Yuta KOREEDA, Tokyo (JP); Masashi EGI, Tokyo (JP)

(21) Appl. No.: 19/533,680

(22) Filed: Feb. 9, 2026

(30) Foreign Application Priority Data
Apr. 25, 2025 (JP) 2025-073409

(51) Int. Cl. G06N 20/00

(52) U.S. Cl. CPC G06N 20/00

(57) ABSTRACT

A machine learning system is configured by computers including a processor that executes a program, a storage device that stores the program, and a communication interface capable of communicating with an external database, wherein the storage device stores domain structure data in which a domain and a group defining a set of the domains exclusive to each other are associated with each other, and the processor executes an extraction process of extracting data related to the domain from the database for each of the domains with reference to the domain structure data, a training process of training a specialized model for each of the domains using data related to the domain extracted through the extraction process, and a combination process of generating a mixed model by selecting a plurality of the domains from the group and combining a plurality of the specialized models related to the plurality of selected domains.

### CLAIM OF PRIORITY

The present application claims priority from Japanese patent application No. 2025-073409 filed on Apr. 25, 2025, the content of which is hereby incorporated by reference into this application.

### BACKGROUND OF THE INVENTION

### 1. Field of the Invention

The present invention relates to a machine learning system, a machine learning method, and a recording medium that execute machine learning.

### 2. Description of the Related Art

In recent years, language models represented by Generative Pre-trained Transformer (GPT) and Bidirectional Encoder Representation from Transformers (BERT) have been remarkably developed. Such language models are also referred to as base models and are used for various downstream tasks such as text generation, document classification, translation, image caption generation, and grammatical analysis. Such language models are learned using a large amount of data. Such language models are monolithic black boxes and cannot change or modify some of the behaviors.

Non-Patent Document 1 discloses a module GShard that includes a series of lightweight annotation application programming interfaces (APIs) and extensions of the accelerated linear algebra (XLA) compiler. GShard provides an elegant method of expressing a wide parallel computational pattern with only making a minimal change to a known model code. With GShard, it is possible to scale up a multilingual neural machine translation transformer model with sparse gated expert mixing to 600 billion parameters or more using automatic sharding.

Non-Patent Document 2 discloses an evolutionary approach that overcomes limitation by automatically detecting effective combinations of various open source models and leveraging collective intelligence without requiring a large amount of additional training data or computing. This approach works in both a parameter space and a data flow space, which results in optimization as well as weights for the individual models. This approach also facilitates cross-domain merging and generates a model such as Japanese LLM with mathematical inference capability.

### PRIOR ART DOCUMENTS

### Non-Patent Documents

Non-Patent Document 1: Lepikhin et al. 2021. GShard: Scaling Giant Models with Conditional Computation and Automatic Sharding. ICLR.
Non-Patent Document 2: Akiba et al. 2024. Evolutionary Optimization of Model Merging Recipes. ArXiv.
Non-Patent Document 3: Newman. 2006. Finding community structure in networks using the eigenvectors of matrices. Physical Review Journals.

### SUMMARY OF THE INVENTION

However, in the above-described technique of Lepikhin et al. 2021. GShard: Scaling Giant Models with Conditional Computation and Automatic Sharding. ICLR., since the language model includes a plurality of specialized models (Expert) and is trained, it is only expected that a plurality of independent structures are provided in the language model and expertise is naturally learned. Accordingly, in practice, it is difficult to find expertise that can be understood by humans in a trained specialized model, and even the expertise cannot be controlled. In addition, Akiba et al. 2024. Evolutionary Optimization of Model Merging Recipes. ArXiv. is merely a technique of combining two or more known language models.

In Akiba et al. 2024. Evolutionary Optimization of Model Merging Recipes. ArXiv., the fact that customization and maintenance are implemented is not taken into account by constructing a group of specialized language models using learning data generated for a domain designed in advance and combining the group of the language models.

An object of the present invention is to implement a modular language model with high maintainability and customization.

One aspect of the present invention disclosed in this application is a machine learning system configured by one or more computers including a processor that executes a program, a storage device that stores the program, and a communication interface capable of communicating with an external database, wherein the storage device stores domain structure data in which a domain and a group defining a set of the domains exclusive to each other are associated with each other, and the processor executes an extraction process of extracting data related to the domain from the database for each of the domains with reference to the domain structure data, a training process of training a specialized model for each of the domains using data related to the domain extracted through the extraction process, and a combination process of generating a mixed model by selecting a plurality of the domains from the group and combining a plurality of the specialized models related to the plurality of selected domains.

According to a representative embodiment of the present invention, it is possible to implement a modular language model with high maintainability and customization. Other objects, configurations, and effects than those described above are clarified by the following description of an embodiment.

### BRIEF DESCRIPTION OF THE DRAWINGS

FIG. 1 is an explanatory diagram illustrating an example of generating a mixed model by a machine learning system according to Example 1.

FIG. 2 is a block diagram for illustrating a hardware configuration example of each of computer.

FIG. 3 is a block diagram illustrating a functional configuration example of a machine learning system according to Example 1.

FIG. 4 is a flowchart illustrating a detailed processing procedure example of the specialized data extraction process by the specialized data extraction unit.

FIG. 5 is an explanatory diagram illustrating an example of the domain structure data.

FIG. 6 is a flowchart illustrating a detailed processing procedure example of the web searching (step S404).

FIG. 7 is a flowchart illustrating a detailed processing procedure example of the exception handling A that is an example of the exception handling.

FIG. 8 is a flowchart illustrating a detailed processing procedure example of the specialized model training process by the specialized model training unit.

FIG. 9 is an explanatory diagram illustrating an example of a token dictionary.

FIG. 10 is a flowchart illustrating an example of a model combination processing procedure by the model combination unit.

FIG. 11 is an explanatory diagram illustrating an example of an adjustment screen.

FIG. 12 is an explanatory diagram illustrating an example of domain structure data according to Example 3.

FIG. 13 is an explanatory diagram illustrating a system configuration example of the machine learning system.

FIG. 14 is an explanatory diagram illustrating an example of domain structure data according to Example 4.

FIG. 15 is an explanatory diagram illustrating an example of a model history of a mixed model.

FIG. 16 is an explanatory diagram illustrating an example of a model history of the specialized model.

FIG. 17 is a flowchart illustrating a detailed processing procedure example of the model combination process according to Example 5.

FIG. 18 is a block diagram illustrating a functional configuration example of the machine learning system 300 according to Example 6.

FIG. 19 is a flowchart illustrating a detailed processing procedure example of a process of generating the domain structure data 100 by the expertise division unit.

FIG. 20 is an explanatory diagram illustrating examples of a co-occurrence relationship graph and an adjacency matrix.

FIG. 21 is an explanatory diagram illustrating an example of a complementary graph of the co-occurrence relationship graph and the adjacency matrix.

FIG. 22 is an explanatory diagram illustrating an example of a use keyword similarity matrix.

FIG. 23 is an explanatory diagram illustrating an example of a masking result.

### DESCRIPTION OF THE PREFERRED EMBODIMENTS

Hereinafter, examples of the present invention will be described with reference to the drawings. However, the present invention is not to be construed as being limited to the description of the embodiments described below. Those skilled in the art can easily understand that the specific configuration of the present invention can be changed without departing from the spirit or gist of the present invention.

In the configurations of the invention to be described below, identical or similar configurations or functions are denoted by the same reference numerals, and repeated description will be omitted.

Notations such as “first”, “second”, “third” and the like in the specification are attached to identify components, and do not necessarily limit the number or order. A position, size, shape, range, and the like of each configuration are illustrated in the drawings and the like in order to facilitate understanding of the invention, and may not represent an actual position, size, shape, range, and the like. Accordingly, the present invention is not limited to the position, size, shape, range, and the like disclosed in the drawings and the like.

### Example 1

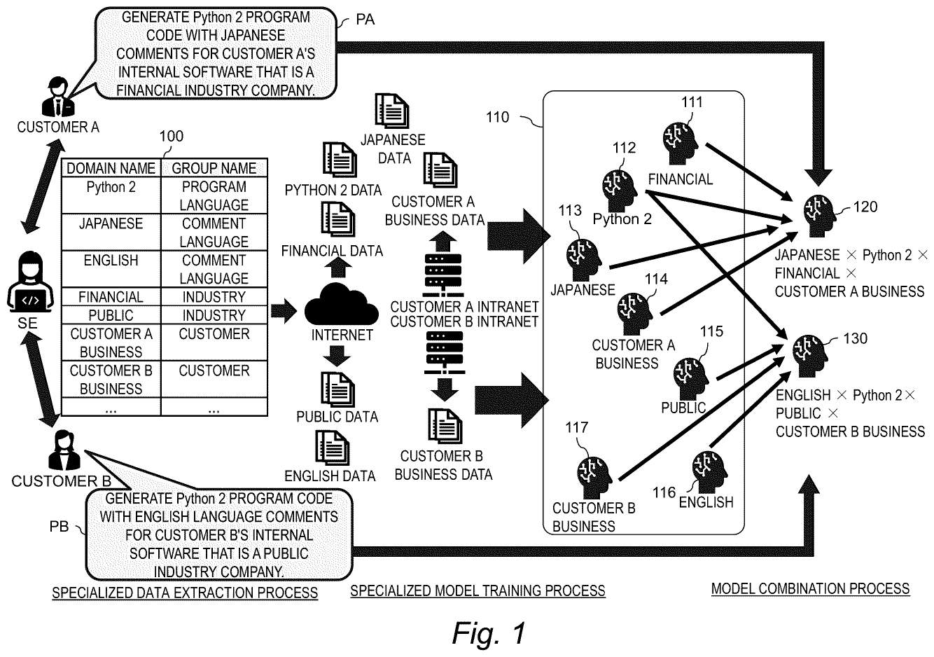

### <FIG. 1: Generation Example of Mixed Model>

FIG. 1 is an explanatory diagram illustrating an example of generating a mixed model by a machine learning system according to Example 1. The machine learning system executes a specialized data extraction process, a specialized model training process, and a model combination process.

The mixed model is a modular language model generated by mixing specialized models. The specialized model is a language model trained with specialized data. The specialized data is data specialized in a specific field or industry. The language model is a probability distribution obtained by modeling human language using an appearance probability of words, and examples of the language model include bidirectional encoder representations from transformers (BERT) and generative pretrained transformer (GPT).

### [Specialized Data Extraction Process (Customer A)]

The machine learning system executes the specialized data extraction process with reference to the domain structure data 100 based on a use purpose of the customer. The domain structure data 100 is information defining a relationship between a domain name and a group name. The domain name is a name of a domain indicating a type of specialized data to be extracted through the specialized data extraction process. The group name is a name of a group to which the domain belongs.

In FIG. 1, as an example, the machine learning system executes the specialized data extraction process according to a use purpose PA: “Generate Python 2 program code with Japanese comments for customer A's internal software that is a financial industry company.” of the customer A determined by hearing between an executor SE of the machine learning system as a system engineer and the customer A.

Specifically, for example, the machine learning system specifies, from the use purpose PA of the customer A, a domain name “financial” belonging to the group name “industry”, a domain name “Python 2” belonging to a group name “program language”, a domain name “Japanese” belonging to a group name “comment language”, and a domain name “customer A business” belonging to a group name “customer”.

The machine learning system extracts, from the Internet, document data (hereinafter referred to as financial data) related to “financial”, document data (hereinafter referred to as Python 2 data) related to “Python 2”, and document data (hereinafter referred to as Japanese data) related to “Japanese” as specialized data. The machine learning system extracts, from the Intranet of the customer A, document data (hereinafter referred to as customer A business data) related to the “customer A business” as specialized data.

### [Specialized Model Training Process (Customer A)]

The machine learning system trains the specialized model using each piece of specialized data extracted through the specialized data extraction process. Specifically, for example, the machine learning system generates a “financial” specialized model 111 through learning using financial data, generates a “Python 2” specialized model 112 through learning using Python 2 data, generates a “Japanese” specialized model 113 through learning using Japanese data, and generates a “customer A business” specialized model 114 through learning using customer A business data. The trained specialized model is added to a specialized model set 110.

### [Model Combination Process (Customer A)]

The machine learning system executes a model combination process of generating a modular language model, that is, a mixed model, by mixing a group of specialized models trained through the specialized model training process based on a use purpose of a customer. In FIG. 1, as an example, the machine learning system generates a mixed model 120 by selecting and combining the “financial” specialized model 111 to the “customer A business” specialized model 114 according to the use purpose PA: “Generate Python 2 program code with Japanese comments for customer A's internal software that is a financial industry company.” of the customer A.

Accordingly, it is possible to speed up service provision by arranging a specialized model group conforming to a business unit of a customer who is a service provider. The machine learning system similarly generates a mixed model 130 for the customer B.

### [Specialized Data Extraction Process (Customer B)]

The machine learning system executes the specialized data extraction process according to the use purpose PB: “Generate Python 2 program code with English comments for internal software of the customer B that is a public industry company.” of the customer B determined in hearing between the executor SE and the customer B.

Specifically, for example, the machine learning system specifies, from the use purpose PB of the customer B, the domain name “public” belonging to the group name “industry”, the domain name “Python 2” belonging to the group name “program language”, the domain name “English” belonging to the group name “comment language”, and the domain name “customer B business” belonging to the group name “customer”.

The machine learning system extracts, from the Internet, document data (public data) related to “public”, Python 2 data (hereinafter referred to as Python 2 data extracted for the customer A may be diverted or may be separately extracted), and document data (hereinafter referred to as English data) related to “English” as specialized data. The machine learning system extracts document data (hereinafter referred to as customer B business data) related to the “customer B business” from an intranet of the customer B as specialized data.

### [Specialized Model Training Process (Customer B)]

The machine learning system generates a “public” specialized model 115 through learning using public data, generates an “English” specialized model 116 through learning using English data, and generates a “customer B business” specialized model 117 through learning using customer B business data. The machine learning system may divert the “Python 2” specialized model 112 trained about the customer A or may relearn using separately extracted Python 2 data. The trained specialized model is added to a specialized model set 110.

### [Model Combination Process (Customer B)]

The machine learning system generates the mixed model 130 by selecting and combining the “Python 2” specialized model 112, and the “public” specialized model 115 to the “customer B business” specialized model 117 according to the use purpose PB: “Generate Python 2 program code with English comments for internal software of the customer B that is a public industry company.” of the customer A. In this way, a new mixed model can be generated by diverting known specialized data and a specialized model.

### <Hardware Configuration Example of Computer>

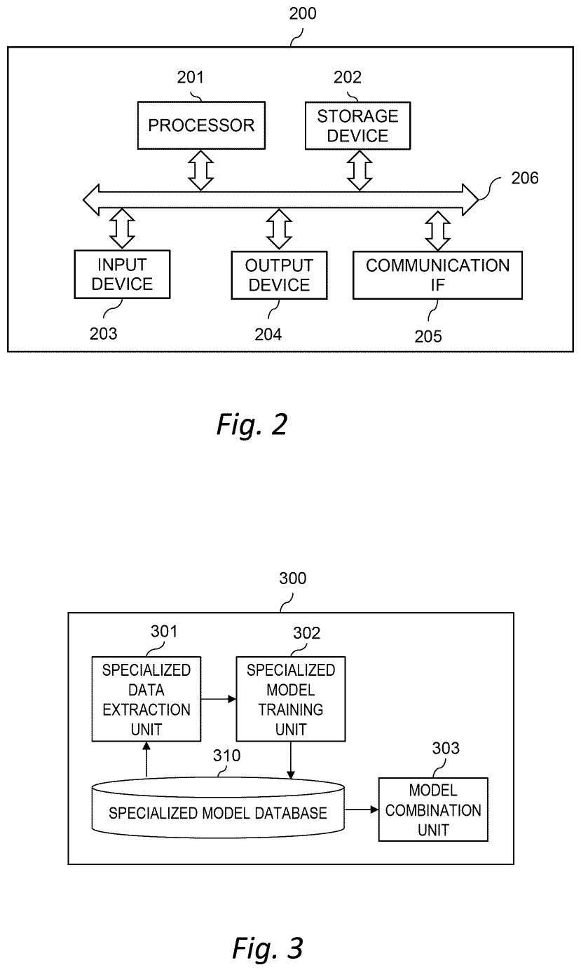

FIG. 2 is a block diagram for illustrating a hardware configuration example of each of computer. A computer 200 includes a processor 201, a storage device 202, an input device 203, an output device 204, and a communication interface (communication IF) 205. The processor 201, the storage device 202, the input device 203, the output device 204, and the communication IF 205 are coupled to one another through a bus 206. The processor 201 is configured to control the computer 200. The storage device 202 serves as a work area for the processor 201. The storage device 202 is also a non-transitory or transitory recording medium configured to store various programs and various kinds of data. Examples of the storage device 202 include a read only memory (ROM), a random-access memory (RAM), a hard disk drive (HDD), and a flash memory. The input device 203 is configured to input data. Examples of the input device 203 include a keyboard, a mouse, a touch panel, a numeric keypad, a scanner and a sensor. The output device 204 is configured to output data. Examples of the output device 204 include a display, a printer, and a speaker. The communication IF 205 is coupled to the network 110, and is configured to transmit and receive data.

### <FIG. 3: Functional Configuration Example of Machine Learning System>

FIG. 3 is a block diagram illustrating a functional configuration example of a machine learning system 300 according to Example 1. The machine learning system 300 outputs a specialized model specialized for a certain application and domain structure data expressing a business range of an executor who conducts a business using the specialized model.

The machine learning system 300 includes one or more computers 200. The machine learning system 300 includes a specialized data extraction unit 301, a specialized model training unit 302, a model combination unit 303, and a specialized model database 310. Specifically, the specialized data extraction unit 301, the specialized model training unit 302, and the model combination unit 303 are, for example, functions implemented by causing the processor 201 to execute a program stored in the storage device 202 illustrated in FIG. 2. Specifically, the specialized model database 310 is stored in, for example, the storage device 202 illustrated in FIG. 2.

The specialized data extraction unit 301 executes the specialized data extraction process illustrated in FIG. 1. Specifically, for example, the specialized data extraction unit 301 receives an input of a domain definition and a group that is a set of exclusive domains, and extracts data related to each domain from the specialized model database 310.

The specialized model training unit 302 executes the specialized model training process illustrated in FIG. 1. Specifically, for example, the specialized model training unit 302 trains a specialized model from data related to each domain extracted by the specialized data extraction unit 301, and stores the specialized model (or a learning parameter) in the specialized model database 310.

The model combination unit 303 executes the model combination process illustrated in FIG. 1. Specifically, for example, the model combination unit 303 selects one or more domains from each group, and generates a mixed model by combining the specialized models corresponding to the selected domains.

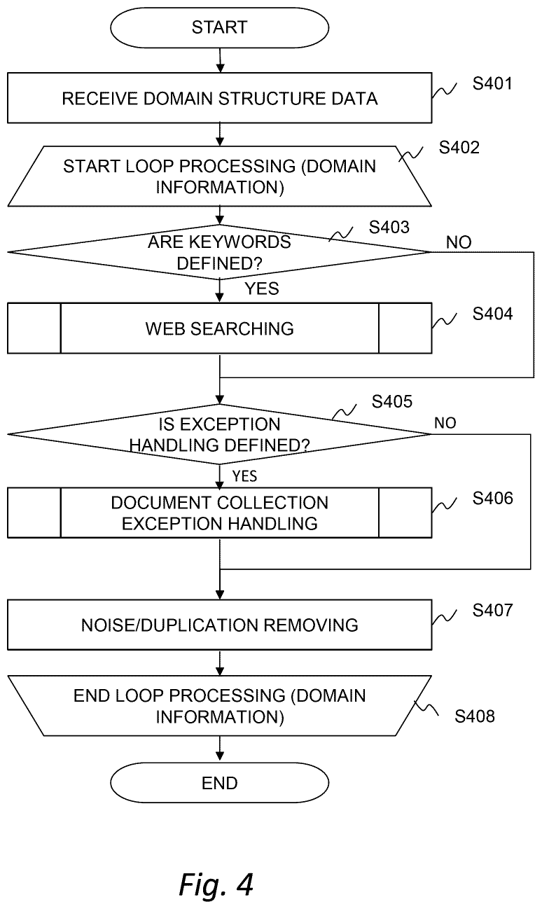

### <FIG. 4: Specialized Data Extraction Process>

FIG. 4 is a flowchart illustrating a detailed processing procedure example of the specialized data extraction process by the specialized data extraction unit 301.

### (Step S401)

The specialized data extraction unit 301 receives an input of the domain structure data 100 (step S201). Here, the domain structure data 100 will be specifically described.

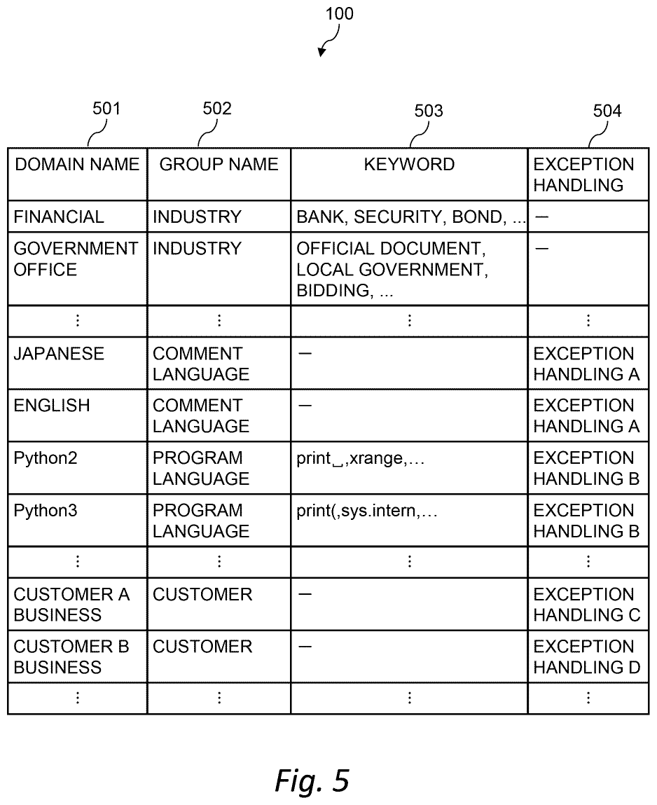

### [FIG. 5: Domain Structure Data]

FIG. 5 is an explanatory diagram illustrating an example of the domain structure data 100. The domain structure data 100 includes, as fields, a domain name 501, a group name 502, a keyword 503, and exception handling 504. A combination of values of the fields 501 to 504 in the same row forms one piece of domain information.

The domain name 501 is a name of a domain. The group name 502 is a name of a group. The keyword 503 is a character string related to the domain name 501 or the group name 502. The exception handling 504 is another document data collection process executed other than the document data collection process by searching of the keyword 503 in the domain information.

For example, the domain structure data 100 is designed manually. In the domain structure data 100, a business scope of the executor is comprehensively and exhaustively included in all groups, mutually exclusive among domain information having the same group name 502.

One of typical components of a group specified with the group name 502 is “industry”, and an organization of the executor is generally designed to express the business scope in a mutually exclusive and exhaustive manner. Therefore, the group may be designed in a form corresponding to the organization of the executor.

The group may correspond to a provided product or service. For example, when a language model for developing a service for business improvement of a customer is applied, a program language or a program comment language for development may be a unit of the group. A customer herself or himself may be regarded as one group. In this case, each customer and a department of the customer are defined as the group name 502.

### (Step S402)

Returning back to FIG. 4, the specialized data extraction unit 301 starts loop processing (S403 to S407) of the domain information (step S402). Specifically, for example, the specialized data extraction unit 301 selects one piece of unselected domain information from the domain structure data 100. The selected domain information is referred to as selected domain information.

### (Step S403)

The specialized data extraction unit 301 determines whether the keyword 503 is defined in the selected domain information. When the keyword 503 is defined in the selected domain information (step S403: Yes), the process proceeds to step S404. When the keyword 503 is not defined in the selected domain information (step S403: No), the process proceeds to step S405.

### (Step S404)

The specialized data extraction unit 301 executes web searching using the keyword 503 of the selected domain information.

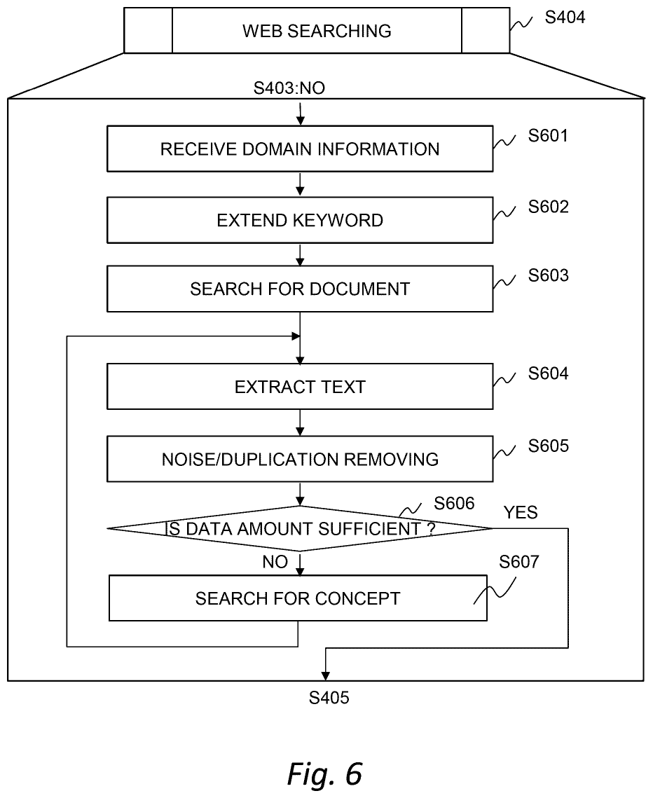

### [FIG. 6: Web Searching (Step S404)]

FIG. 6 is a flowchart illustrating a detailed processing procedure example of the web searching (step S404).

### (Step S601)

The specialized data extraction unit 301 receives an input of the selected domain information.

### (Step S602)

The specialized data extraction unit 301 extends the keyword 503 of the selected domain information. Specifically, for example, the specialized data extraction unit 301 adds synonyms of the keyword 503 to the keyword 503 using a synonym dictionary. As a means other than the synonym dictionary, the specialized data extraction unit 301 may acquire a similar representation from a language model, or may search for a term serving as a superordinate concept from an article of WordNet or Wikipedia and add the term to the keyword 503. In step S602, it is possible to select whether execution is enabled or disabled by setting in advance.

### (Step S603)

The specialized data extraction unit 301 executes document data searching for each of the keywords 503 of the selected domain information, and stores the searched document data group. In the searching, an external Internet search engine, a search engine configured on document data prepared by the executor, or a combination thereof may be used. The document data means a set of data including text information, and may be data including a book, a print, a form, a document, or text obtained by digitizing spoken voice of a paper medium, and a form of the document data does not matter, such as a web page, an electronic book, a presentation, a portable document format (PDF: Registered Trademark) file including a chart or an image, a code repository, a knowledge graph, or encrypted data.

### (Step S604)

The specialized data extraction unit 301 extracts text from the document data group searched in step S603. When the document data is a HyperText Markup Language (HTML) file searched by an Internet search engine, a textual element (content of tags such as <p>, <div>, and <h1>) included in a <body> tag or below is extracted. A party easily understands that an electronic medium other than an HTML file can be processed without departing from the gist of the present invention by incorporating a parser for each electronic medium or a machine learning method such as a Generative Pre-trained Transformer (GPT)-4V.

### (Step S605)

The specialized data extraction unit 301 removes noise and duplication from the document data group searched in step S603. Specifically, for example, the specialized data extraction unit 301 executes duplication removing in units of document data using a uniform resource identifier (URI) or other ID associated with the document data.

The specialized data extraction unit 301 may use a MinHash algorithm or the like to execute removing other than one of the document data groups sharing a certain partial byte string or more. The specialized data extraction unit 301 may remove document data including a certain amount or more of specific characters (parentheses and the like) suggesting that the specific characters are derived from codes of a web page instead of a natural language, or document data including a specific keyword (a social networking service (SNS) name suggesting that the specific characters are derived from SNS, “contents” suggesting that an amount of information is small, and the like). The process of removing noise and duplication may be a process that is based on a rule, a process that is based on machine learning, or a process of requesting correction from a user.

### (Step S606)

Subsequently, the specialized data extraction unit 301 determines whether the data amount of the text extracted from the document data group in step S604 is equal to or greater than a threshold. The threshold is empirically determined according to use of large language models (LLMs), and is typically, for example, 100 megabytes or more in terms of text encoded with unicode. However, as the threshold, units such as the number of characters, the number of words, and the number of tokens may be used in addition to the number of bytes.

When it is determined that the data amount is the threshold or more (step S606: Yes), the specialized data extraction unit 301 ends the web searching (step S404) and the process proceeds to step S405. When it is determined that the data amount is not sufficient (step S606: No), the process proceeds to step S607.

### (Step S607)

The specialized data extraction unit 301 executes concept search of the text extracted from the document data group in step S604, and attempts to expand the document data group searched in step S603. Specifically, for example, the specialized data extraction unit 301 vectorizes the text extracted from the document data group in step S604 with word2vec.

The specialized data extraction unit 301 searches for document data including text of which cosine similarity to a vector representation is equal to or greater than a predetermined value from the vector database, and adds the searched document data to the document data group searched in step S603. This vector database is a database that stores various types of document data and a vector representation obtained by vectorizing text in the document data with word2vec in advance.

However, in the concept searching (step S607), a vector representation such as SentenceBERT or bag-of-words may be used. In the concept searching (step S607), link destinations of the URLs included in the text of the document data group searched in step S603 may be collected instead of the concept searching. The above process is the concept searching (step S607), and the process proceeds to step S405.

### (Step S405)

Returning back to FIG. 4, the specialized data extraction unit 301 determines whether the exception handling 504 for document data collection is defined in the selected domain information. When the exception handling 504 for document data collection is defined in the selected domain information (step S405: Yes), the process proceeds to step S406. When the exception handling 504 for document data collection is not defined in the selected domain information (step S405: No), the process proceeds to step S407.

### (Step S406)

The specialized data extraction unit 301 executes the exception handling 504 for document data collection. The specialized data extraction unit 301 collects document data based on the exception handling 504 defined in the selected domain information and adds the document data to the document data group searched in step S603, and the process proceeds to step S407.

As an example of the exception handling 504, exception handling A for collecting a program code repository including a Japanese comment from an online code repository will be described.

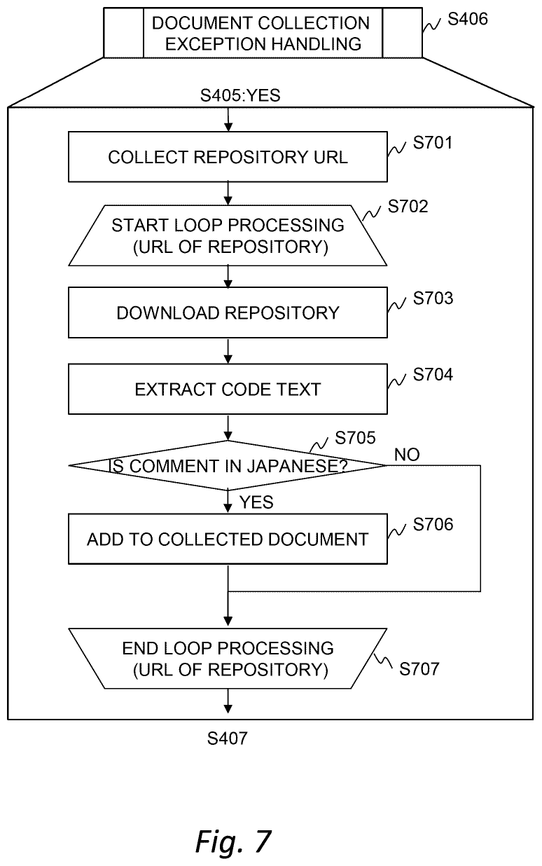

### [FIG. 7: Exception Handling A]

FIG. 7 is a flowchart illustrating a detailed processing procedure example of the exception handling A that is an example of the exception handling 504.

### (Step S701)

The specialized data extraction unit 301 collects a URL group of the repository by utilizing a search function of the online code repository. At this time, a main programming language of the code repository may be Python, or filtering that is based on evaluation of the repository may be executed.

### (Step S702)

The specialized data extraction unit 301 starts loop processing of the URL group of the repository collected in step S701. Specifically, for example, the specialized data extraction unit 301 selects one unselected URL from the URL group of the repository collected in step S701. The selected URL is referred to as a selected URL.

### (Step S703)

The specialized data extraction unit 301 downloads the repository from the selected URL.

### (Step S704)

The specialized data extraction unit 301 extracts the code text from the repository downloaded in step S703. Specifically, for example, the specialized data extraction unit 301 scans files in the repository, selects files having an extension of .py, and extracts and combines code text in each of the selected files.

### (Step S705)

The specialized data extraction unit 301 determines whether the code comment written in the repository downloaded in step S703 is in Japanese. Specifically, for example, the specialized data extraction unit 301 extracts a row starting with # or a row surrounded by “′” or ‘′’ using a regular expression, and classifies the language using Langdetect. At this time, although complete comment extraction cannot be executed in principle with a regular expression, it is sufficient in view of the purpose of roughly extracting learning data.

When the code comment written in the repository downloaded in step S703 is in Japanese (step S705: Yes), the process proceeds to step S706. When the code comment written in the repository downloaded in step S703 is not in Japanese (step S705: No), the process proceeds to step S707. However, a library other than Langdetect may be used for language determination, or a rule-based or machine learning-based language determination system may be newly constructed.

### (Step S706)

The specialized data extraction unit 301 adds the code text of the repository of which the comment is determined to be in Japanese to the document data group searched in step S603.

### (Step S707)

The specialized data extraction unit 301 ends the loop processing of the URL group of the repository collected in step S701. Specifically, for example, the specialized data extraction unit 301 determines whether there is an unselected URL. When there is an unselected URL, the process returns to step S702. When there is no unselected URL, the exception handling A ends.

### (Step S407)

Returning back to FIG. 4, the specialized data extraction unit 301 removes noise and duplication of the document data group searched in step S603. This processing is similar to the processing in step S605.

### (Step S408)

The specialized data extraction unit 301 ends the loop processing of the domain information (S403 to S407). Specifically, for example, the specialized data extraction unit 301 determines whether there is unselected domain information. When there is unselected domain information, the process returns to step S402. When there is no unselected domain information, the loop processing ends. The document data group collected in this way is stored in the specialized model database 310. Accordingly, the specialized data extraction process by the specialized data extraction unit 301 ends.

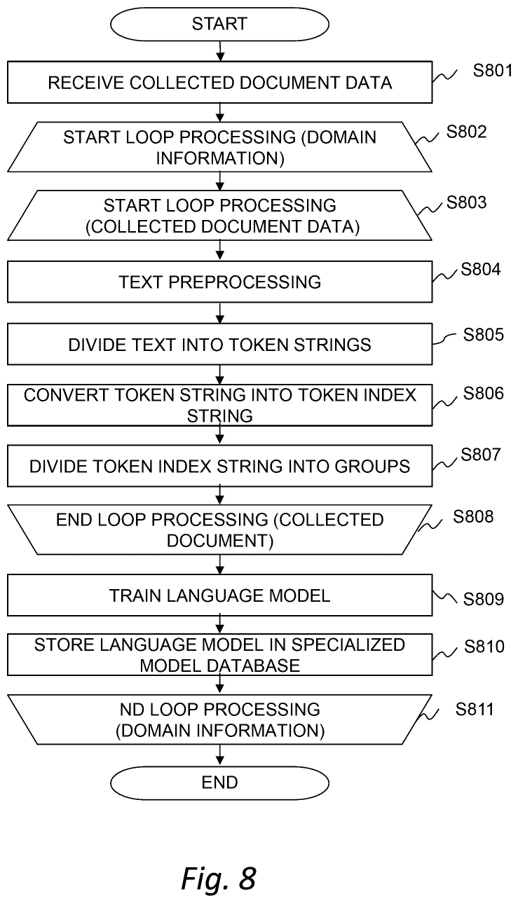

### <FIG. 8: Specialized Model Training Process>

FIG. 8 is a flowchart illustrating a detailed processing procedure example of the specialized model training process by the specialized model training unit 302.

### (Step S801)

The specialized model training unit 302 receives a text group of the document data group extracted by the specialized data extraction unit 301.

### (Step S802)

The specialized model training unit 302 starts loop processing (S803 to S808) of the domain information. Specifically, for example, the specialized model training unit 302 selects one piece of unselected domain information from the domain structure data 100. The selected domain information is referred to as selected domain information.

### (Step S803)

The specialized model training unit 302 starts loop processing of the document data group (hereinafter referred to as a “document data group related to the selected domain information”) extracted through the specialized data extraction process on the selected domain information. Specifically, for example, the specialized model training unit 302 selects unselected document data from a document data group related to the selected domain information. The selected document data is referred to as selected document data. For example, when the domain name 501 of the selected domain information is “financial”, the selected document data is financial data.

### (Step S804)

The specialized model training unit 302 executes preprocessing of the text in the selected document data. Specifically, for example, the specialized model training unit 302 deletes a space character at the beginning of the end of a sentence and normalizes the space from the text in the selected document data. In this preprocessing, normalization of unicode or correction of erroneous conversion of an optical character reader (OCR) may be executed.

### (Step S805)

The specialized model training unit 302 divides the text in the selected document data into a token string including one or more tokens. The token string is divided based on byte pair encoding, but may be divided into morphemes or different units.

### (Step S806)

The specialized model training unit 302 converts the token string divided in step S805 into a token index string {t0, t1, . . . , tP−1} including P integers using a token dictionary.

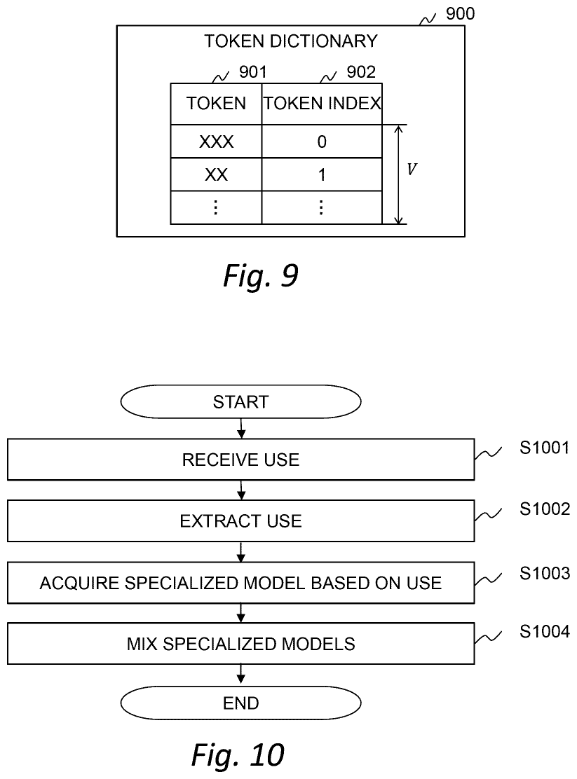

### [FIG. 9: Token Dictionary]

FIG. 9 is an explanatory diagram illustrating an example of a token dictionary. A token dictionary 900 is a data table in which a token 901 and a token index 902 are associated with each other. Accordingly, the token 901 can be converted into the token index 902.

### (Step S807)

Returning back to FIG. 8, the specialized model training unit 302 divides the token index string converted in step S806 into groups. The token index number included in one group is set in advance in view of the number of token indexes required to be generated by an assumed application and an amount of GPU memory required for learning. A remainder generated when the token index strings are grouped in order from the front is disposed in front of the group in the next step S807.

### (Step S808)

The specialized model training unit 302 ends the loop processing of the document data group related to the selected domain information for the selected domain information. Specifically, for example, the specialized model training unit 302 determines whether there is unselected document data in the document data group related to the selected domain information. When there is unselected document data, the process returns to step S803. When there is no unselected document data, the process proceeds to step S809.

### (Step S809)

The specialized model training unit 302 executes training of a language model. Specifically, for example, the specialized model training unit 302 collects n groups from a bunch of groups obtained through the division in step S807 to form m units called mini-batches. That is, m mini-batches that are a set of n groups are generated.

The specialized model training unit 302 calculates a probability yi of a token index xi at an ith (where i is an integer of 1 or more) for each mini-batch in each of the n groups based on a token index string up to an (i−1)th token index (Formula (1) below).

yi=p(ti|θ,t0,t1, . . . ,ti−1) (1)

Here, θ is a parameter of a specialized model. The specialized model training unit 302 trains the specialized model by executing optimization of Formula (2) below using the probability yi, that is, by obtaining the minimum learning parameter θ that maximizes the probability yi of Formula [2].

argminθ−ΣkΣjΣi log(yi) (2)

Here, j is an index (0≤j≤(n−1)) for specifying a group in the mini-batch. In addition, k is an index for specifying the mini-batch (0≤k≤(m−1)).

A mini-batch stochastic gradient descent method using momentum or weight attenuation like AdamW is used to derive an optimization problem of Formula (2) above. Here, a technique such as learning rate scheduling and distributed learning may be employed for optimization. In addition to the mini-batch stochastic gradient descent method, a method using second-order differentiation, evolution calculation, or the like may be used.

The specialized model may be implemented by a model that is based on a transformer architecture such as T5 or Llama-2, a model that is based on recursive calculation such as Long Short Term Memory (LSTM) or Reception Weighted Key Value (RWKV), or a model that is based on distributed calculation such as GShard.

The learning parameter θ of the specialized model may be randomly initialized, or the learning parameter θ of a language model trained in advance with other data may be used. Any model capable of processing information other than text may be used, for example, a model such as LLaVa capable of receiving both an image and text as an input, a model such as MiniGPT4-Video capable of receiving both video and text as an input, and a model such as AudioPaLM capable of receiving both voice and text as an input. A non-generative model such as bidirectional encoder representations from transformers (BERT) may be used for the classification use instead of the generation model.

### (Step S810)

The specialized model training unit 302 stores the specialized model (or the learning parameter θ) trained in step S809 in the specialized model database 310 together with the selected domain information.

### (Step S811)

The specialized model training unit 302 ends the loop processing of the domain information (S803 to S808). Specifically, for example, the specialized model training unit 302 determines whether there is unselected domain information in the domain structure data 100. When there is unselected domain information, the process returns to step S803. When there is no unselected domain information, the loop processing (S803 to S808) of the domain information ends. Accordingly, the specialized model training process by the specialized model training unit 302 ends.

In the present example, the example in which only text of the document data group extracted by the specialized data extraction unit 301 is used for learning has been described. However, in order to prevent catastrophic forgetting or to cause the language model to learn a desired behavior, text data other than the specialized data, shaped data for fine tuning, human interaction data, a generation result of another language model, or the like may be used in combination.

In this combined use, the text data may be mixed with the text of the document data group, or the text data may be learned in a plurality of stages in order. Furthermore, in addition to learning based on next word prediction exemplified in the present example, learning may be executed by using or in combination with a method such as reinforcement learning from human feedback or direct policy optimization.

### <FIG. 10: Model Combination Process>

FIG. 10 is a flowchart illustrating an example of a model combination processing procedure by the model combination unit 303.

### (Step S1001)

The model combination unit 303 receives an input of a use of a language model implemented by the machine learning system 300. The use is received, for example, in text from the input device 203. Here, as an example of the use, it is assumed that a text “Generate Python 2 program code with Japanese comments for customer A's internal software that is a financial industry company” is received.

### (Step S1002)

The model combination unit 303 extracts the use of the language model implemented by the machine learning system 300 from the use input in step S1001. Specifically, for example, the model combination unit 303 selects the domain name 501 corresponding to the group name 502 included in the use from the domain structure data 100.

For example, in the case of the use “Generate Python 2 program code with Japanese comments for customer A's internal software that is a financial industry company” described above, “financial” of the domain name 501 is selected from “industry” of the group name 502, “Japanese” of the domain name 501 is selected from “comment language” of the group name 502, “Python 2” of the domain name 501 is selected from “program language” of the group name 502, and “customer A” of the domain name 501 is selected from “customer” of the group name 502.

The model combination unit 303 may select one or less domain name 501 from each of the group names 502 of the domain structure data 100 and one or more domain names 501 in the entire group name 502.

However, for example, when the use is for a customer that is not in the “customer” of the group name 502, there is no domain name 501 to be selected from the group name 502 in some cases.

### (Step S1003)

The model combination unit 303 acquires the specialized model implemented by the machine learning system 300 from the specialized model database 310 based on the use for each use extracted in step S1002. In the specialized model database 310, a specialized model (or a learning parameter θ) is stored in association with domain information used for the learning (step S810). Accordingly, the model combination unit 303 extracts, from the specialized model database 310, the specialized model (or the learning parameter θ) associated with the domain information including the domain name 501 as the use extracted in step S1002.

In the above example, the domain names 501 extracted as uses are “financial”, “Japanese”, “Python 2”, and “customer A”. Accordingly, a “financial” specialized model (or the learning parameter θ) trained with the domain information including “financial” in the domain name 501, a “Japanese” specialized model (or the learning parameter θ) trained with the domain information including “Japanese” in the domain name 501, a “Python 2” specialized model (or the learning parameter θ) trained with the domain information including “Python 2” in the domain name 501, and a “customer A” specialized model (or the learning parameter θ) trained with the domain information including “customer A” in the domain name 501 are extracted from the specialized model database 310.

### (Step S1004)

The model combination unit 303 mixes these specialized models acquired in step S1003 to generate a mixed model configured as a modular type. Specifically, for example, in the above example, the model combination unit 303 aggregates values of the learning parameters θ of the “financial” specialized model, the “Japanese” specialized model, the “Python 2” specialized model, and the “customer A” specialized model as a weighted linear sum, and sets the values as the learning parameters θ of the new mixed model.

At this time, a mixing ratio (a weight of the weighted linear sum) of each learning parameter θ is empirically or experimentally determined, is stored in the specialized model database 310, and is read during the execution of step S1004. Specifically, for example, an executor subjectively evaluates outputs of a plurality of mixed models mixed at different mixing ratios by the model combination unit 303 in advance, and selects an optimum mixing ratio. However, the model combination unit 303 may search for a mixing ratio using performance with evaluation data that can be quantitatively evaluated, such as a classification problem, as an objective function. In addition to the simple linear sum, an algorithm of Spherical Linear Interpolation (SLERP) that executes aggregation of the learning parameter θ on the spherical surface or Trim, Elect Sign and Merge (TIES Merge) that executes aggregation based on a difference in the learning parameter θ from a common ancestor model may be used.

When there is no common architecture among the plurality of specialized models, the model combination unit 303 may mix the specialized models in a form in which an output of a certain specialized model in a transformer layer is input to a transformer layer of another specialized model. This corresponds to configuring a new language model by aggregating or increasing the number of learning parameters by inserting the transformer layer of another language model into the language model, swapping the transformer layer of one language model and the transformer layer of the other language model, deleting the transformer layer of the language model, or a combination thereof.

Instead of aggregating the learning parameters θ of the plurality of specialized models to configure the learning parameter θ of the new mixed model, the model combination unit 303 may generate a language model subjected to ensemble learning based on an output of one or more specialized models as a mixed model.

For example, a token index string q representing an input such as a question or an instruction is assumed to be q=[q₀, q₁, . . . , q_{M-1}]. A case is conceivable in which when the token index string q is input, text is generated with a mixed model in which a “financial” specialized model SM0, a “Japanese” specialized model SM1, a “Python 2” specialized model SM2, and a “customer A” specialized model SM(D−1) having learning parameters θ₀, θ₁, θ₂, and θ_{D-1}(D=4) are combined respectively.

First, the model combination unit 303 recursively generates a token index t_{(d, i)} by a greedy method for each specialized model SMd, acquires a dth generated token index string [t_{(d, 0)}, t_{(d, 1)}, . . . , t_{(d, Nd-1)}] (see Formula (3) below). That is, t_{(d, 1)} at which p(t_{(d, 1)}|θ_{d}, q₀, q₁, . . . , q_{(M-1)}, t_{(d, 0)}, t_{(d, 1)}, . . . , t_{(d, Nd-1)}) is maximum is selected by Formula (3) below. In Formula (3) below, t_{(d, 1)} is an ith token index 902 in the dth generated token index string. Nd is a length (specifically, for example, a length to a special token such as <EOS>) of the dth generated token index string.

argmaxₜ_{_{d,i}}p(t_{d,i}|θ_{d},q₀,q₁, . . . ,q_{M-1},t_{d,0},t_{d,1}, . . . t_{d,N}_{_{d}}₋₁) (3)

Subsequently, each specialized model SMd votes on a generation result of each specialized model SMd, and determines a most likely generated token index string. Specifically, the model combination unit 303 specifies a d\hat{ }th generated token index string in which a sum of log likelihoods of the generated token index strings q in all the specialized models SM1 to SM(D−1) is maximum (see Formula (4) below).

$$\hat{d} = arg {max}_{d} \frac{1}{D} {\sum }_{{d}^{′} = 0}^{D} \text{} \frac{1}{{N}_{d}} \text{} {\sum }_{i = 0}^{{N}_{d} - 1} \text{} log \text{} \text{} p ( \text{} {t}_{d , i} \vert {θ}_{d ′} , \\ {q}_{o} , {q}_{1} , … , {q}_{M - 1} , {t}_{d , 0} , {t}_{d , 1} , … , {t}_{d , {N}_{d} - 1} ) \qquad ( 4 )$$

Finally, the model combination unit 303 compares the token index t_{(d\hat{ }, i)} with the token index 902 of the token dictionary 900 for each token index t_{(d\hat{ }, i)} of the selected d\hat{ }th generated token index string to obtain the token 901 corresponding to the token index 902. The model combination unit 303 outputs the generated text by combining the token 901 corresponding to the entire token index of the selected d\hat{ }th generated token index string.

Instead of determining the generated text by the voting, the model combination unit 303 may integrate and summarize the generated text (which may be image data) from each of the plurality of specialized models in one language model. Alternatively, the model combination unit 303 may sequentially generate the generated text (which may be image data) of the “financial” specialized model such that the “Python 2” specialized model edits the generated text, the “Japanese” specialized model edits the edited generated text, and the “customer A” specialized model edits the edited generated text (which may be image data).

As described above, according to Example 1, it is possible to quickly provide a service to a customer by preparing a specialized model group conforming to a business unit of an executor who provides the service by the mixed model configured in a modular manner.

### Example 2

In Example 2, a configuration in which an executor determines a mixing ratio of a mixed model empirically or experimentally while simply checking an output of the mixed model in Example 1 will be described. In Example 2, in order to mainly describe differences from Example 1, the same components as those of Example 1 are denoted by the same reference numerals, and description of the same contents will be omitted.

In Example 2, the model combination unit 303 is different from that in Example 1. Specifically, for example, this is an example in which the mixing ratio (a weight ratio of a weighted linear sum) can be adjusted by an operation of the executor. According to the adjusted mixing ratio, the model combination unit 303 executes a model combination process.

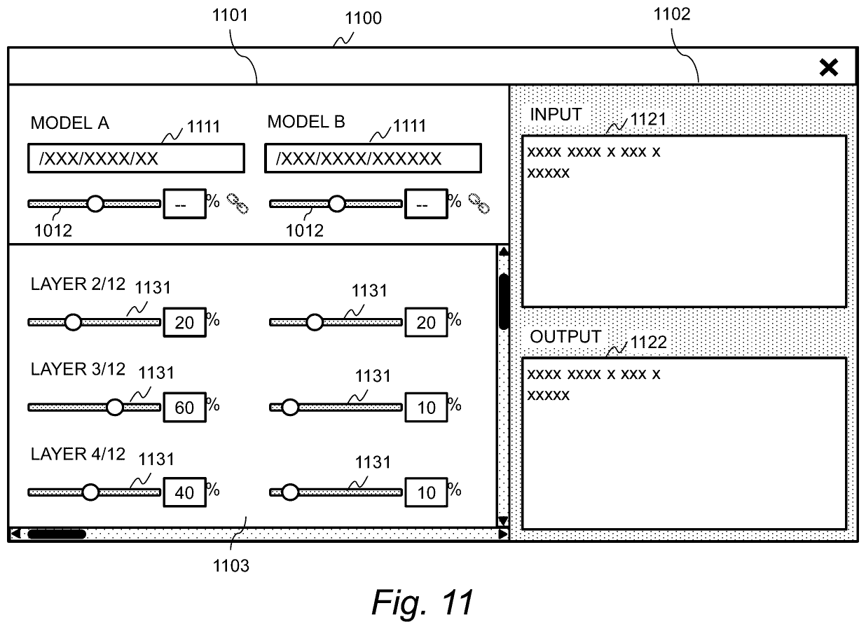

### <FIG. 11: Adjustment Screen>

FIG. 11 is an explanatory diagram illustrating an example of an adjustment screen. An adjustment screen 1100 is displayed on a display device that is an example of an output device 204. The adjustment screen 1100 includes a model-specific mixing ratio adjustment region 1101, an input/output region 1102, and a stratified mixing ratio adjustment region 1103.

The model-specific mixing ratio adjustment region 1101 is a region where a mixing ratio of a specialized models is adjusted for each specialized model that is a model combination target, and includes a model designation text box 1111 and a slider 1112. The model designation text box 1111 is a user interface that receives input of a character string for designating the specialized model. The slider 1112 is a user interface that receives adjustment of the mixing ratio of the specialized models.

The input/output region 1102 includes an input region 1121 and an output region 1122. The input region 1121 is a user interface that receives an input of any text. Text input to the input region 1121 is input to the mixed model in which the mixing ratio is adjusted in the model-specific mixing ratio adjustment region 1101. The output region 1122 is a user interface that displays an output result from the mixed model as a result obtained by inputting the text input to the input region 1121 to the mixed model.

The stratified mixing ratio adjustment region 1103 is a region where the mixing ratio of the intermediate layer is adjusted for each intermediate layer of the specialized model that is a model combination target, and includes a slider 1131. The slider 1131 is a user interface that receives adjustment of the mixing ratio of the intermediate layer of the specialized model.

The executor can select an optimum mixing ratio by subjectively evaluating an output result of the mixed model at different mixing ratios adjusted in the model-specific mixing ratio adjustment region 1101 or the stratified mixing ratio adjustment region 1103.

As described above, according to Example 2, the executor can determine the mixing ratio of the mixed model empirically or experimentally while simply checking the output result of the mixed model.

### Example 3

In Example 3, a configuration in which only a specialized model required to be corrected or updated in Example 1 or Example 2 is retrained will be described. In Example 3, in order to mainly describe differences from Example 1 and Example 2, the same configurations as those of Example 1 and Example 2 are denoted by the same reference numerals, and description of the same contents will be omitted. In Example 3, it is assumed that the machine learning system 300 is already used one or more times and one or more specialized models are stored in the specialized model database 310.

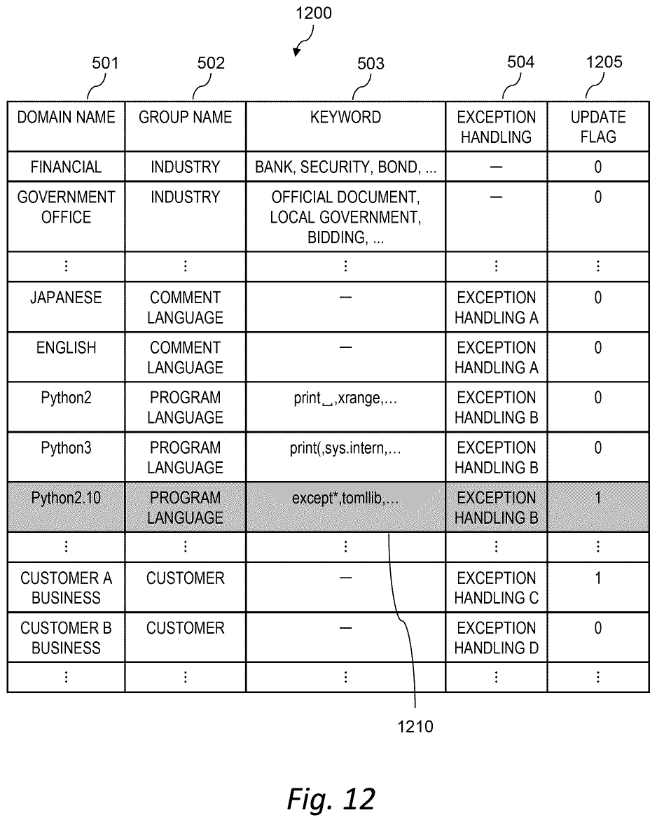

### <FIG. 12: Domain Structure Data>

FIG. 12 is an explanatory diagram illustrating an example of domain structure data according to Example 3. A domain structure data 1200 includes a domain name 501, a group name 502, a keyword 503, exception handling 504, and an update flag 1205. A combination of values of the fields 501 to 504 and 1205 in the same row forms one piece of domain information.

The update flag 1205 is a flag indicating whether update target data is updated. The update target data is data related to the domain information and is, for example, document data associated with the domain information. The update flag is “1” or “0”, and “1” indicates that there is an update, and “0” indicates that there is no update.

The update flag 1205 is set to “1” when the document data associated with the domain information is updated for some reason. For example, when a new version (Python 2.10) is added to a certain program (Python 2), the executor sets the domain information 1210 in which the domain name 501 is “Python 2.10”, the group name 502 is “program language”, and the exception handling 504 is “exception handling B” in the domain structure data 1200. In the example of FIG. 12, except*, tomllib, . . . are set as the keyword 503 of the domain information 1210. The update flag 1205 is set to “1”.

The update flag 1205 can be set to “1” even when the document data is corrected in a case where confidential information, sensitive information, or information infringing a right of another person is mixed in the document data associated with the domain information, in a case where there is an error or other incompleteness, in a case where there is erroneous information, or the like.

The update flag 1205 may be set by explicitly executing an operation of the executor. When the document data actually associated with the domain information is extracted through the specialized data extraction process and a collected document data group is changed, the specialized data extraction unit 301 may set the update flag 1205 to “1”.

### <FIG. 4: Specialized Data Extraction Process>

In the specialized data extraction process (FIG. 4) by the specialized data extraction unit 301 according to Example 3, the process is executed only on the domain information of which the update flag 1205 is “1”.

### <FIG. 8: Specialized Model Training Process>

Even in the specialized model training process (FIG. 8) by the specialized model training unit 302 according to Example 3, the process is executed only on domain information of which the update flag 1205 is “1”. Thereafter, when the execution of the specialized model training process (FIG. 8) ends for the domain information of which the update flag 1205 is “1”, the update flag 1205 is changed from “1” to “0”.

According to Example 3, it is possible to retrain only a specialized model required to be corrected or updated in the specialized model set 110, and high maintainability can be implemented.

### Example 4

In Example 4, a configuration in which a specialized model learned in a first environment (Examples 1 to 3) and a specialized model learned in a second environment different from the first environment are combined in a second environment according to Examples 1 to 3 will be described. In Example 4, in order to mainly describe differences from Examples 1 to 3, the same components as those of Examples 1 to 3 are denoted by the same reference numerals, and description of the same contents will be omitted.

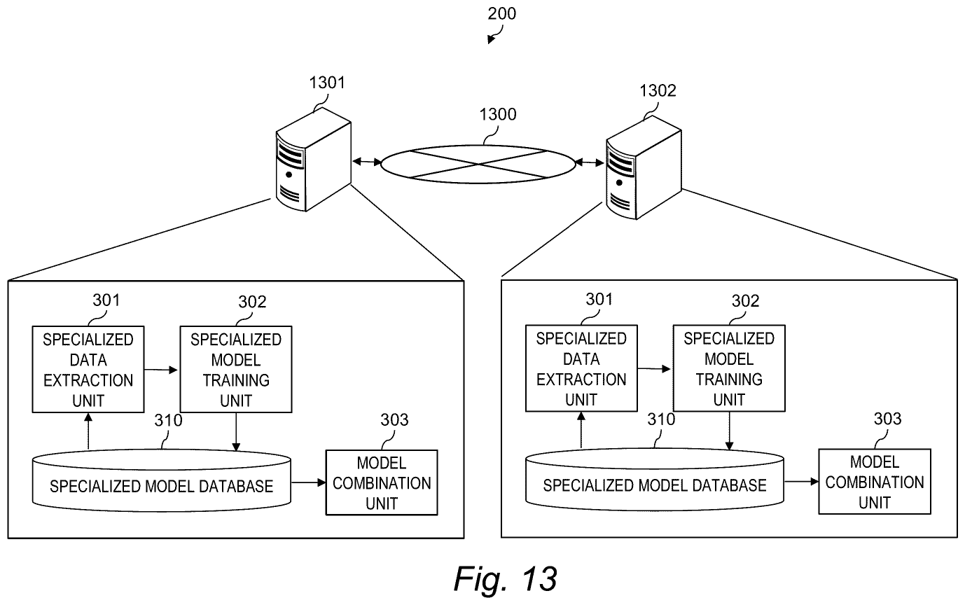

### <FIG. 13: System Configuration Example of Machine Learning System 300>

FIG. 13 is an explanatory diagram illustrating a system configuration example of the machine learning system 300. The machine learning system 300 according to Example 4 has a configuration in which a plurality of computers (the first computer 1301 and the second computer 1302 are illustrated in FIG. 13) are communicably connected via a network 1300. The first computer 1301 is a computer in a first environment, and the second computer 1302 is a computer in a second environment. Although FIG. 13 illustrates the connection configuration of two computers as an example, three or more computers may be connected. When the first computer 1301 and the second computer 1302 are not distinguished from each other, these computers are referred to as computer 200.

The network 1300 is, for example, the Internet, a local area network (LAN), or a wide area network (WAN). A connection scheme of the network 1300 may be either wired or wireless. The network 1300 is not required to be always connected, and may be virtually implemented by means such as physical movement of the computer 200, or temporary connection of a recording media to the first computer 1301 and the second computer 1302 and physical movement of a recording medium.

The configuration illustrated in FIG. 3 is implemented in each of the first computer 1301 and the second computer 1302. In Example 4, domain structure data common to the first computer 1301 and the second computer 1302 is used.

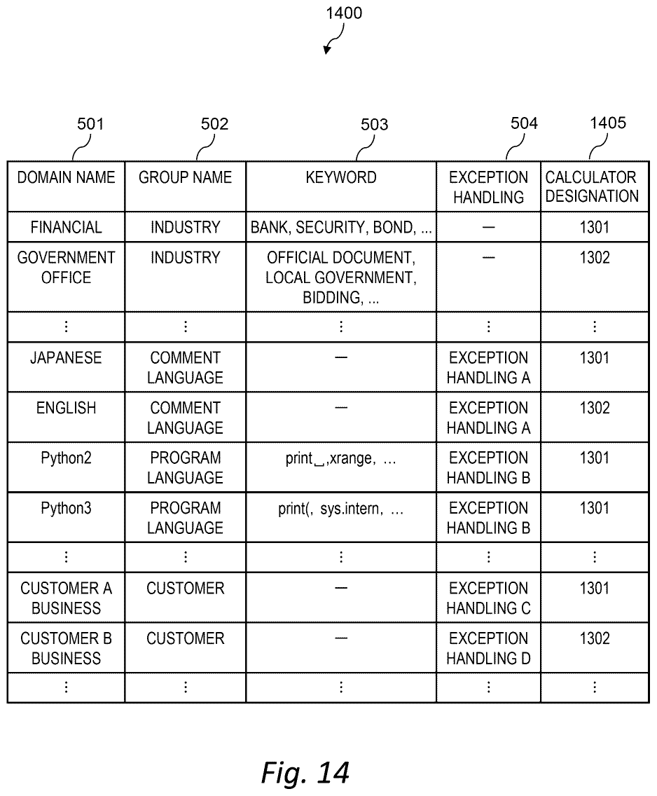

### <FIG. 14: Domain Structure Data>

FIG. 14 is an explanatory diagram illustrating an example of domain structure data according to Example 4. The domain structure data 1400 includes a domain name 501, a group name 502, a keyword 503, exception handling 504, and computer designation 1405. A combination of values of the fields 501 to 504 and 1405 in the same row forms one piece of domain information.

The computer designation 1405 is identification information for uniquely identifying the computer 200 that can use the domain information for learning. In FIG. 14, the identification information is a code assigned to the computer 200. The computer designation 1405 can be set by the user in view of data access right management, an access speed caused by data locality, and the like.

### <FIG. 4: Specialized Data Extraction Process>

Each of the first computer 1301 and the second computer 1302 independently executes the specialized data extraction process, but selects domain information satisfying the computer designation 1405 when unselected domain information is selected in step S402. Specifically, for example, the first computer 1301 selects only unselected domain information of which the computer designation 1405 is “1301”, and the second computer 1302 selects only unselected domain information of which the computer designation 1405 is “1302”

### <FIG. 8: Specialized Model Training Process>

Similarly, each of the first computer 1301 and the second computer 1302 independently executes the specialized model training process, but selects domain information satisfying the computer designation 1405 when unselected domain information is selected in step S802. Specifically, for example, the first computer 1301 selects only unselected domain information of which the computer designation 1405 is “1301”, and the second computer 1302 selects only unselected domain information of which the computer designation 1405 is “1302”.

### <FIG. 10: Model Combination Process>

Each of the first computer 1301 and the second computer 1302 independently executes the model combination process. When a specialized model (or a learning parameter θ) that is not in the specialized model database 310 of the first computer 1301 is used, the first computer 1301 acquires the specialized model from the second computer 1302 in step S1003. Similarly, when a specialized model (or a learning parameter θ) that is not in the specialized model database 310 of the second computer 1302 is used, the second computer 1302 acquires the specialized model from the first computer 1301 in step S1003.

Accordingly, each computer 200 generates the mixed model by acquiring the specialized model (or a learning parameter θ) insufficient for generating the mixed model from the other computer 200. For example, a case where the first computer 1301 generates the mixed model 120 of the customer A and the second computer 1302 generates the mixed model 130 of the customer B in FIG. 1 will be described as an example.

In this case, the “Python 2” specialized model 112 is in the specialized model database 310 of the first computer 1301, and the “Python 2” specialized model 112 is not in the specialized model database 310 of the second computer 1302. The second computer 1302 can generate the mixed model 130 by acquiring the “Python 2” specialized model 112 (or a learning parameter θ) from the first computer 1301.

Accordingly, since the second computer 1302 is not required to extract Python 2 data in the specialized data extraction process or train the “Python 2” specialized model 112 in the specialized model training process, a calculation load of the second computer 1302 is reduced. In particular, as in federated learning, the second computer 1302 can train a specialized model having a scale exceeding a scale that can be normally learned by a calculation capability of the second computer 1302.

Since the second computer 1302 is not required to store the Python 2 data and the “Python 2” specialized model 112 in the specialized model database 310 of the second computer 1302, memory saving can be achieved.

### Example 5

In Example 5, a configuration in which data indicating a model history is output in addition to a specialized model in Examples 1 to 4 will be described. In Example 5, in order to mainly describe differences from Examples 1 to 4, the same components as those of Examples 1 to 4 are denoted by the same reference numerals, and description of the same contents will be omitted.

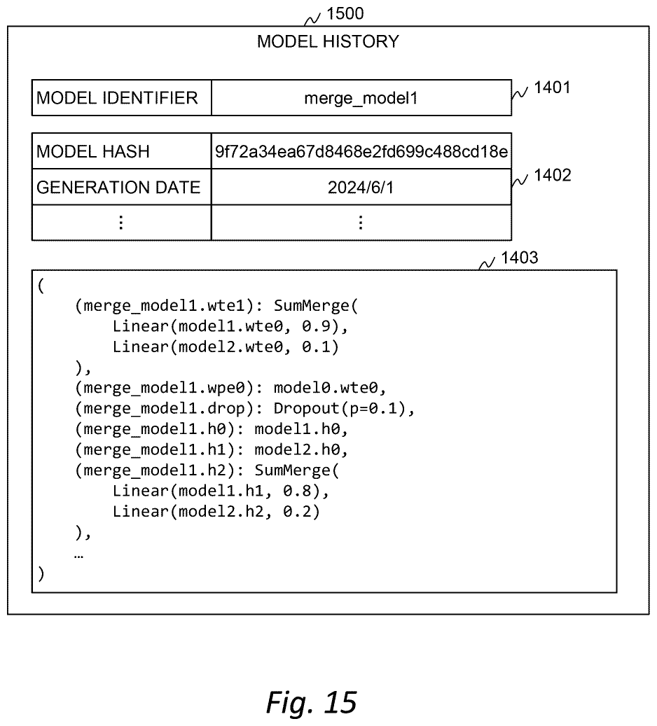

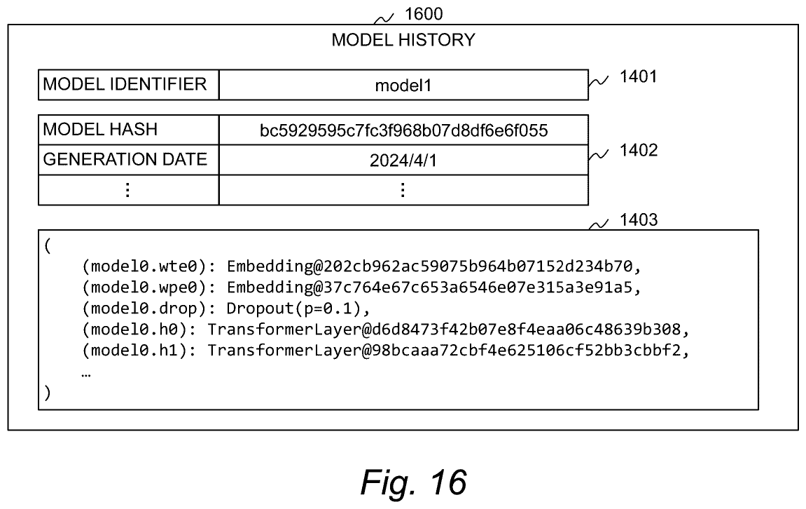

### <FIGS. 15 and 16: Model History>

FIG. 15 is an explanatory diagram illustrating an example of a model history of a mixed model. FIG. 16 is an explanatory diagram illustrating an example of a model history of the specialized model.

Model history information 1500 in FIG. 15 and model history information 1600 in FIG. 16 include a model identifier 1501, model information 1502, and a model recipe 1503. The model identifier 1501, the model information 1502, and the model recipe 1503 are stored in the storage device 202. Model history information 1500 in FIG. 15 and model history information 1600 in FIG. 16 are displayed on a display that is an example of the output device 204.

The model identifier 1501 is an identifier of a model that is a mixed model or a specialized model, and may be in any form as long as this model identifier is unique in one configuration of the machine learning system 300.

In the model information 1502, any information regarding the mixed model or the specialized model is stored. The stored information may be any information contributing to use of the mixed model or the specialized model, such as a hash value of a file included in the mixed model or the specialized model, a generation date, a generator, information regarding data used for learning, and a license. The model information 1502 is updated whenever the mixed model or the specialized model is updated.

In the model recipe 1503, a configuration method of a mixed model or a specialized model is stored, such that, in the case of the mixed model in FIG. 15, information regarding how layers of other mixed models are combined is included in the configuration method of the mixed model in the model recipe 1503 of the model history information 1500. For example, in this example, it can be understood that the layer wte1 is a result of a linear sum of a layer wte0 of a mixed model having a model identifier model1 and a layer wte0 of a mixed model having a model identifier model2 at 9:1. The model recipe 1503 is updated whenever the mixed model or the specialized model is updated.

In the case of the specialized model, in FIG. 16, since the specialized model is a language model trained by the specialized model training unit 302, information capable of uniquely identifying each layer is stored in the model recipe 1503 of the model history information 1600 in the specialized model configuration method.

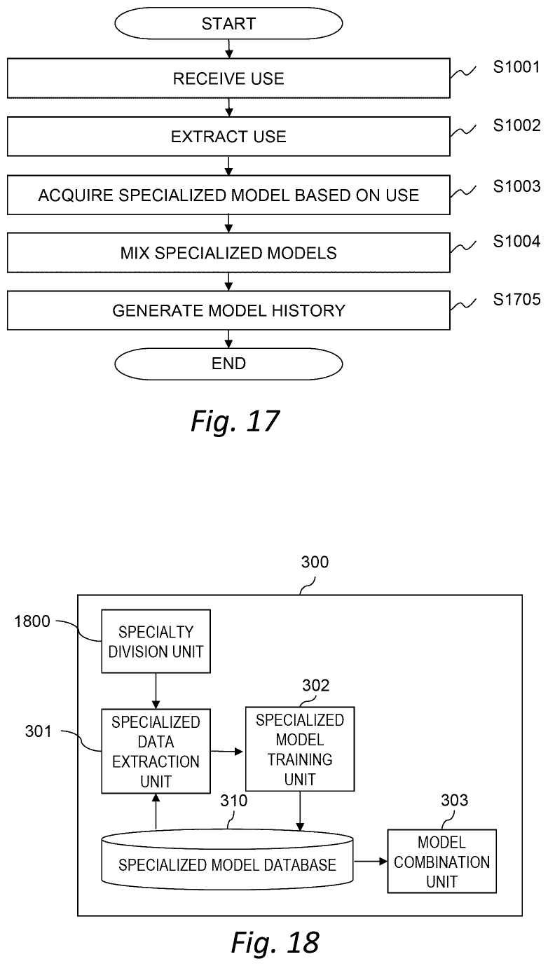

### <FIG. 17: Model Combination Process>

FIG. 17 is a flowchart illustrating a detailed processing procedure example of the model combination process according to Example 5. The model combination process according to Example 5 is a process of executing step S1705 after step S1004 illustrated in FIG. 10.

### (Step S1705)

The model combination unit 303 generates pieces of model history information 1500 and 1600. By generating the model history information 1500 of the mixed model, it is possible to specify the history of the mixed model. By generating the model history information 1600 of all the specialized models used for the mixing, it is possible to specify the history of the specialized model. According to Example 5, the user can track a history of the mixed model and the specialized model.

### Example 6

In Example 6, a method of automatically configuring domain structure data by inputting a use implemented by the machine learning system 300 in one or more applications in Examples 1 to 5 will be described. In Example 6, in order to mainly describe differences from Examples 1 to 5, the same components as those of Examples 1 to 5 are denoted by the same reference numerals, and description of the same contents will be omitted.

### <FIG. 18: Functional Configuration Example of Machine Learning System>

FIG. 18 is a block diagram illustrating a functional configuration example of the machine learning system 300 according to Example 6. The machine learning system 300 includes an expertise division unit 1800 in addition to the configuration of Example 1. Specifically, the expertise division unit 1800 is a function implemented, for example, by causing the processor 201 to execute a program stored in the storage device 202 illustrated in FIG. 2.

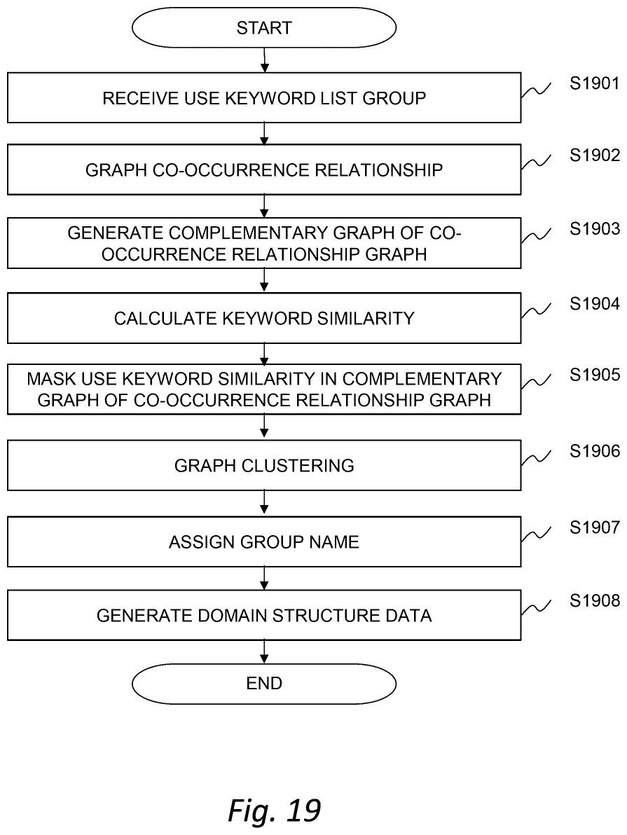

The expertise division unit 1800 generates the domain structure data 100 with reference to a set of use keyword lists indicating a use of one or more applications. A specific process of the expertise division unit 1800 will be described with reference to FIG. 19.

### <FIG. 19: Expertise Division Process>

FIG. 19 is a flowchart illustrating a detailed processing procedure example of a process of generating the domain structure data 100 by the expertise division unit 1800.

### (Step S1901)

The expertise division unit 1800 receives an input of the use keyword list group by operating the input device 203. The use keyword list group is wo or more use keyword lists. The use keyword list is a keyword list in which the use of the language model implemented by the machine learning system 300 in a certain application is expressed as a set of one or more use keywords.

In Example 6, a use keyword list group including four use keyword lists of “financial, Python 2, Japanese”, “Python 2, financial, English”, “government office, customer A business, Japanese”, and “English, Python 3, financial” will be described as an example. The keywords in the same use keyword list have a co-occurrence relationship.

Instead of the use keyword list group, the expertise division unit 1800 may receive a plurality of uses such as reception by the model combination unit 303 in step S1001, and configure the use keyword list using a rule or a topic model for each use.

### (Step S1902)

The expertise division unit 1800 graphs the co-occurrence relationship of the use keywords in the use keyword list group.

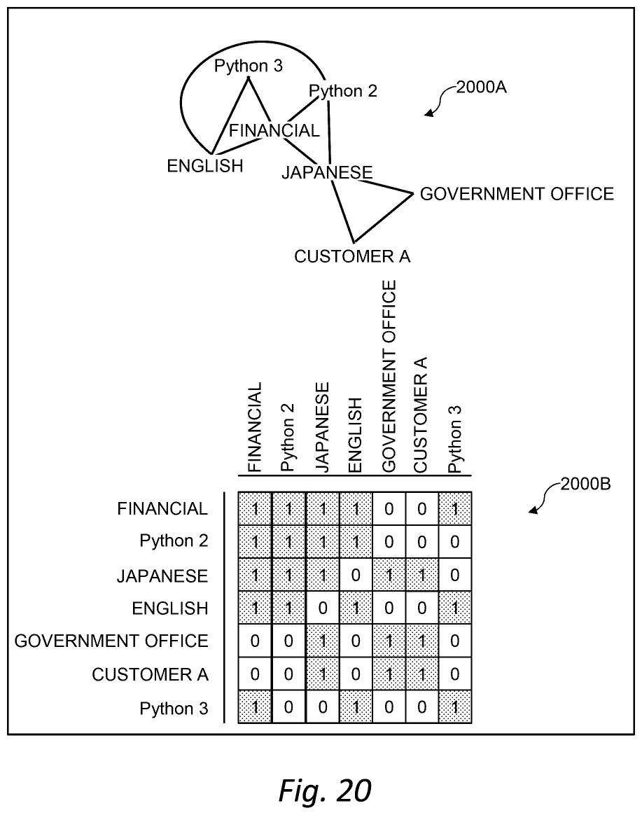

### [FIG. 20: Co-Occurrence Relationship Graph and Adjacency Matrix]

FIG. 20 is an explanatory diagram illustrating examples of a co-occurrence relationship graph and an adjacency matrix. A co-occurrence relationship graph 2000A is generated in step S1902. The co-occurrence relationship graph 2000A includes a use keyword in the use keyword list group and a link that connects the co-occurrence relationship between two use keywords in the use keyword list between the two use keywords.

For example, when the use keyword list “financial, Python 2, Japanese” is given as an example, “financial” and “Python 2” are connected to each other because of co-occurrence, “financial” and “Japanese” are connected to each other because of co-occurrence, and “Japanese” and “Python 2” are connected to each other because of co-occurrence.

The co-occurrence relationship of the use keywords can be expressed by an adjacency matrix of “1” when the two use keywords co-occur and “0” when the two use keywords do not co-occur. That is, the co-occurrence relationship graph 2000A is expressed by an adjacency matrix 2000B.

### (Step S1903)

Returning back to FIG. 19, the expertise division unit 1800 generates a complementary graph of the co-occurrence relationship graph 2000, and the process proceeds to step S1904.

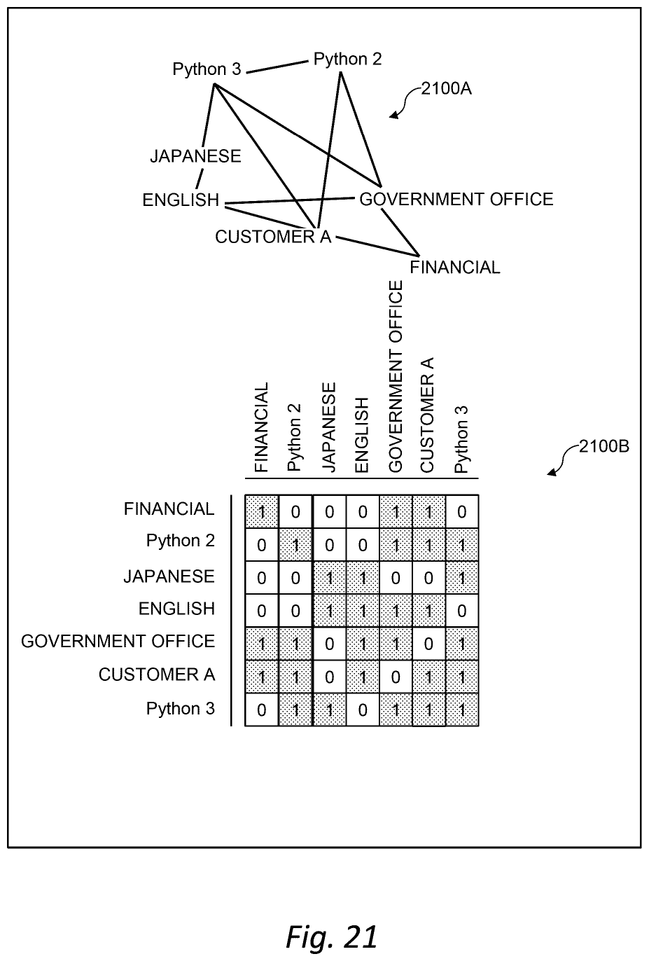

### [FIG. 21: Complementary Graph of Co-Occurrence Relationship Graph 2000A and Adjacency Matrix]

FIG. 21 is an explanatory diagram illustrating an example of a complementary graph of the co-occurrence relationship graph 2000A and the adjacency matrix. A complementary graph 2100A is a complementary set of the co-occurrence relationship graph 2000. An adjacency matrix 2100B of the complementary graph 2100A is obtained by subtracting 1 from non-diagonal elements of the adjacency matrix 2000B of the co-occurrence relationship graph 2000A and taking an absolute value.

When the number or a ratio of non-zero elements in the adjacency matrix 2100B of the complementary graph 2100A is equal to or greater than a threshold, the expertise division unit 1800 may generate a complementary graph including a vertex group that is non-adjacent and has a distance of a constant n or less instead of deriving the complementary graph 2100A. The distance is the number of sides connecting two vertexes. For example, in the co-occurrence relationship graph 2000A of FIG. 20, “Python 3” and “government office” are not directly connected. Therefore, in the complementary graph 2100A, these are connected by sides. If n=2 is set, the distance between “Python 3” and “government office” in the co-occurrence relationship graph 2000A of FIG. 20 is 3. Therefore, a complementary graph with no side between “Python 3” and “government office” is generated. Accordingly, it is possible to erase a side having a distance of n or more in the co-occurrence relationship graph 2000A from the complementary graph. The number or a ratio of non-zero elements serving as conditions is set in advance.

### (Step S1904)

Returning back to FIG. 19, the expertise division unit 1800 calculates similarity between the use keywords. Specifically, the expertise division unit 1800 calculates cosine similarity between distributed representation vector representations of use keywords for all use keyword pairs included in the use keyword list group.

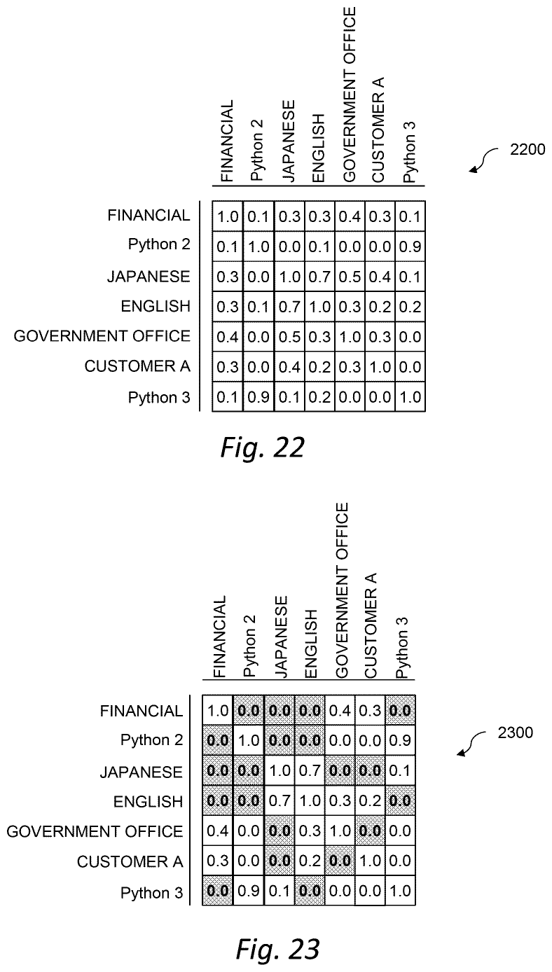

### [FIG. 22: Use Keyword Similarity Matrix]

FIG. 22 is an explanatory diagram illustrating an example of a use keyword similarity matrix. A use keyword similarity matrix 2200 is a calculation result of the cosine similarity between the distributed representation vector representations of the use keywords calculated in step S1904. Each element of the use keyword similarity matrix 2200 is referred to as use keyword similarity. The distributed representation vector representation may be obtained using word2vec, or may be obtained using any distributed representation vector calculation method such as SentenceBERT.

### (Step S1905)

Returning back to FIG. 19, the expertise division unit 1800 masks the use keyword similarity of the use keyword similarity matrix 2200 with the complementary graph 2100A of the co-occurrence relationship graph 2000A.

### [FIG. 23: Masking Result]

FIG. 23 is an explanatory diagram illustrating an example of a masking result. The expertise division unit 1800 calculates an element product of the adjacency matrix 2100B representing the complementary graph 2100A of the co-occurrence relationship graph 2000A and the use keyword similarity matrix 2200. As a result, a masking result 2300 is obtained.

### (Step S1906)

Returning back to FIG. 19, the expertise division unit 1800 executes graph clustering (community analysis) based on the masking result 2300 in step S1905. For graph clustering, for example, a method based on an eigenvector is used as described in Newman. 2006. Finding community structure in networks using the eigenvectors of matrices. Physical Review Journals. By executing the graph clustering, the use keyword list group grouped such as “financial and government office”, “Python 2, Python 3”, “Japanese, English”, and “customer A business” is obtained.

Any algorithm such as a method based on search or a method based on a label propagation method may be used for the graph clustering. The use of the complementary graph 2100A of the co-occurrence relationship graph 2000A ensures that the use keywords belonging to the same group are mutually exclusive. By using the use keyword similarity matrix 2200, it is ensured that use keywords having close content belong to the same group.

### (Step S1907)

The expertise division unit 1800 assigns a group name to each group of the use keyword list group grouped in step S1906. Specifically, for example, the expertise division unit 1800 generates a prompt for requesting assignment of a group name and inputs the generative AI. For example, the expertise division unit 1800 converts a group name that appropriately expresses a set of keywords of “______” for each group (use keyword list) of the grouped use keyword list group. Please explain only the group name in one word” to generate a prompt. The expertise division unit 1800 acquires a response from the generative AI as a group name.

Instead of using the generative AI, a process of requesting a user to assign the group name via a user interface may be executed.

### (Step S1908)

The expertise division unit 1800 generates the domain structure data 100 based on the use keyword list group grouped in step S1906 and the group name assigned in step S1906. Specifically, for example, the expertise division unit 1800 generates the domain structure data 100 with each keyword of the use keyword list group grouped in step S1906 as the domain name 501 and the group name assigned in step S1906 as the group name 502.

For example, the use keyword list group grouped in step S1906 is “financial, government office”, “Python 2, Python 3”, “Japanese, English”, and “customer A business” in the above example. It is assumed that “industry” is given as a group name of “financial, government office”, “program language” is given as a group name of “Python 2, Python 3”, “comment language” is given as a group name of “Japanese, English”, and “customer” is assigned as a group name of “customer A business”.

In this case, the expertise division unit 1800 sets a domain name 501 “financial” and a group name 502 “industry”, sets a domain name 501 “government office” and a group name 502 “industry”, sets a domain name 501 “Python 2” and a group name 502 “program language”, sets a domain name 501 “Python 3” and a group name 502 “program language”, sets a domain name 501 “Japanese” and a group name 502 “comment language”, sets a domain name 501 “English” and a group name 502 “comment language”, and sets a domain name 501 “customer A business” and a group name 502 “customer”.

The user is prompted to input the keyword 503 and the exception handling 504. Accordingly, the process executed by the expertise division unit 1800 ends. According to Example 6, the user can semi-automatically perform individual-type and high-load expertise design in the machine learning system 300.

It should be noted that this disclosure is not limited to the above-mentioned embodiments, and encompasses various modification examples and the equivalent configurations within the scope of the appended claims without departing from the gist of this disclosure. For example, the above-mentioned embodiments are described in detail for a better understanding of this disclosure, and this disclosure is not necessarily limited to what includes all the configurations that have been described. Further, a part of the configurations according to a given embodiment may be replaced by the configurations according to another embodiment. Further, the configurations according to another embodiment may be added to the configurations according to a given embodiment. Further, a part of the configurations according to each embodiment may be added to, deleted from, or replaced by another configuration.

Further, a part or entirety of the respective configurations, functions, processing modules, processing means, and the like that have been described may be implemented by hardware, for example, may be designed as an integrated circuit, or may be implemented by software by a processor interpreting and executing programs for implementing the respective functions.

The information on the programs, tables, files, and the like for implementing the respective functions can be stored in a storage device such as a memory, a hard disk drive, or a solid state drive (SSD) or a recording medium such as an IC card, an SD card, or a DVD.

Further, control lines and information lines that are assumed to be necessary for the sake of description are described, but not all the control lines and information lines that are necessary in terms of implementation are described. It may be considered that almost all the components are connected to one another in actuality.

What is claimed is:

1. A machine learning system configured by one or more computers including a processor that executes a program, a storage device that stores the program, and a communication interface capable of communicating with an external database,
wherein the storage device stores domain structure data in which a domain and a group defining a set of the domains exclusive to each other are associated with each other, and
the processor executes
an extraction process of extracting data related to the domain from the database for each of the domains with reference to the domain structure data,
a training process of training a specialized model for each of the domains using data related to the domain extracted through the extraction process, and
a combination process of generating a mixed model by selecting a plurality of the domains from the group and combining a plurality of the specialized models related to the plurality of selected domains.

2. The machine learning system according to claim 1, wherein the data related to the domain is at least text data between the text data and image data.

3. The machine learning system according to claim 1, wherein, in the combination process, the processor combines two or more of the specialized models through at least one of combinations of aggregation and increase of learning parameters of two or more of the specialized models.

4. The machine learning system according to claim 1, wherein, in the combination process, the processor combines two or more of the specialized models by adding or subtracting output probability distributions of the two or more of the specialized models.

5. The machine learning system according to claim 1, wherein, in the combination process, the processor combines a plurality of the specialized models by inputting an output from each of the plurality of specialized models to a language model and generating text data or image data.

6. The machine learning system according to claim 1,
wherein the processor executes a generation process of generating the domain structure data by generating one or more clusters including keywords that have a similarity relationship and are mutually exclusive from a plurality of keyword groups indicating a use of a language model and by setting keywords in the clusters as the domain and setting the clusters as the group, and
in the extraction process, the processor extracts data related to the domain from the database for each of the domains with reference to the domain structure data generated through the generation process.

7. The machine learning system according to claim 1, wherein, in the combination process, the processor receives an input of a setting value for combining the specialized models for each of the domains, and displays information regarding the mixed model.

8. The machine learning system according to claim 1, wherein, in the combination process, the processor outputs history information indicating which specialized models are mixed by a mathematical formula.

9. A machine learning method by a machine learning system configured by one or more computers including a processor that executes a program, a storage device that stores the program, and a communication interface capable of communicating with an external database,
wherein the storage device stores domain structure data in which a domain and a group defining a set of the domains exclusive to each other are associated with each other, and
the processor executes
an extraction process of extracting data related to the domain from the database for each of the domains with reference to the domain structure data,
a training process of training a specialized model for each of the domains using data related to the domain extracted through the extraction process, and
a combination process of generating a mixed model by selecting a plurality of the domains from the group and combining a plurality of the specialized models related to the plurality of selected domains.

10. A recording medium that non-transitorily records a machine learning program causing a machine learning system configured by one or more computers including a processor that executes a program, a storage device that stores the program, and a communication interface capable of communicating with an external database to execute machine learning, and is capable of reading the machine learning program to the processor,
wherein the storage device stores domain structure data in which a domain and a group defining a set of the domains exclusive to each other are associated with each other, and
the processor executes
an extraction process of extracting data related to the domain from the database for each of the domains with reference to the domain structure data,
a training process of training a specialized model for each of the domains using data related to the domain extracted through the extraction process, and
a combination process of generating a mixed model by selecting a plurality of the domains from the group and combining a plurality of the specialized models related to the plurality of selected domains.
